(19) United States
(12) Patent Application Publication
(10) Pub. No.: US 2017/0258096 A1
(43) Pub. Date: Sep. 14, 2017

(54) COMPOSITIONS AND METHODS TO TREAT PLANT PATHOGENS

(71) Applicant: Coats Agri Aloe, LLC, Plano, TX (US)

(72) Inventor: Billy C. Coats, Garland, TX (US)

(21) Appl. No.: 15/453,639

(22) Filed: Mar. 8, 2017

Related U.S. Application Data
(60) Provisional application No. 62/305,015, filed on Mar. 8, 2016.

(51) Int. Cl. A01N 65/42; A01N 43/12; A01N 25/04

(52) U.S. Cl. CPC A01N 65/42; A01N 25/04; A01N 43/12

(57) ABSTRACT

The present invention includes compositions and methods for treating one or more pathogens that affect plants comprising: identifying a plant or seed in need of treatment of a plant; obtaining a whole leaf aloe vera extract and adding aloin, wherein the aloe vera leaf is processed to eliminate solids and to preserve the gel of the aloe vera gel; and at least one of diluting the whole leaf aloe vera extract and spraying the whole leaf aloe vera extract on the plant or seed, wherein the aloe vera gel and aloin at least one of stop the growth of, reduce the spread of, or kill the one or more pathogens on the plant or reduce the amount of infected plants that arises from the treatment of seeds.

### CROSS-REFERENCE TO RELATED APPLICATIONS

This application claims priority to U.S. Provisional Application Ser. No. 62/305,015 filed Mar. 8, 2016, the entire contents of which are incorporated herein by reference.

### TECHNICAL FIELD OF THE INVENTION

The present invention relates in general to the field of treatments for plants, and more particularly, to compositions and methods for the treatment of plants pathogens.

### BACKGROUND OF THE INVENTION

Without limiting the scope of the invention, its background is described in connection with the treatment of plants against pathogens.

In recent years, research and development efforts for the treatment of plant pathogens has focused on two main approaches, chemical and genetic. Over the years, more and more powerful chemical agents have been developed and refined to prevent and treat plants. These chemical agents are designed or isolated to affect a critical reproductive step in the growth, maturation or division of the target organism. However, more often than not, the chemical agent has an effect on other plants and animals.

Examples of methods for protecting fruits may be found in U.S. Pat. No. 4,946,694, issued to Gunnerson, et al., for a “Liquid coating for fruits.” These inventors teach an improved coating for sticky fruits and a process for preparing such coated fruits. More particularly, the coating of the invention comprises a vegetable wax, a vegetable oil, a wetting agent and a protein. The process is said to include the steps of: (a) coating the fruit with a composition that includes a wetting agent and a suspension of a vegetable wax in a vegetable oil, (b) adding to the fruit a composition with a protein, (c) removing excess mixture from the fruit, and (d) drying the fruit. However, the addition of protein greatly increases the cost of the application and provides a potential substrate for attachment.

Yet another chemical coating is taught in U.S. Pat. No. 4,039,470, issued to Kalmar, entitled “Preservative coating for fruits and vegetables.” This inventor coats fruits with a finely atomized spray of an acid solution of benzimidazole that must be retained in a separate corrosion resistant chamber prior to being mixed with the wax or resin solution just prior to application. However, unlike the teachings of this patent, the present invention does not have to be put into a corrosive chamber.

Yet another coating is taught in U.S. Pat. No. 4,783,342, issued to Polovina and entitled, “Polymeric film coating method for protecting plants, vegetables and fruit from drought,” which relates to a method of preserving plants during periods of drought by applying a solid, water permeable film which controls water loss, to the surface of the plants. The same film can also be used to preserve vegetables and fruit. The water permeable film is also effective to preserve cut flowers.

Finally, U.S. Pat. No. 5,922,774, issued to Winslow teaches a method for controlling plant damage by insect herbivores. Briefly, this patent teaches using chemically-synthesized anthraquinones to repelling insect herbivores from plant surfaces and deterring them from feeding on plant surfaces by applying an aqueous dispersion of polycyclic quinone or precursor thereof to the foliage of the plant and/or to the surrounding soil in which the plant is rooted.

Despite the many efforts in this regard, nature finds a way to circumvent and select for those pathogens that are no longer resistant to the chemical or the genetic modification. Furthermore, these methods are most useful for those crops and plants that are replaced seasonally or yearly. Trees, plants and crops that live for many years before replacement, however, are unable to benefit from the genetic manipulation. Furthermore, many, many trees, plants and crops have not been able to be readily manipulated. These plants are still in need of protection and treatment from pathogens without an effect on the local environment, plants and fauna.

### SUMMARY OF THE INVENTION

In one embodiment, the present invention includes a method for treating one or more pathogens that affect plants comprising: identifying a plant or seed in need of treatment of a plant; obtaining a whole leaf aloe vera extract and adding aloin in an amount sufficient to stop the growth of, reduce the spread of, or kill the one or more pathogens on the plant or reduce the amount of infected plants that arises from the treatment of seeds, wherein the aloe vera leaf is processed to eliminate solids and to preserve the gel of the aloe vera gel; and at least one of diluting the whole leaf aloe vera extract and spraying the whole leaf aloe vera extract on the plant or seed, wherein the aloe vera gel and aloin and at least one of stop the growth of, reduce the spread of, or kill the one or more pathogens on the plant or reduce the amount of infected plants that arises from the treatment of seeds. In one aspect, the aloe vera is processed into a liquid, a gel, is dry, is ground, is freeze-dried, heat dried, vacuum dried, air-dried, spray-dried, or combinations thereof.

In another aspect, the plant comprises a grass, a grain, a fruit or a vegetable. In another aspect, the whole leaf aloe vera extract is diluted to 20, 15, 10, 9, 8, 7, 6, 5, 4, 3, 2, or 1% in a plant growth media or water prior to use on the plant or seed. In another aspect, the plant is an orange, grapefruit, lemon, lime, mandarin, Satsuma, kumquat, jojoba, apple, cocoa, cacao, coffee or other flowering plant. In another aspect, the composition increased leaf greenness (SPAD), and showed a significant gain in net photosynthesis (PN). In another aspect, the composition is used to treat Brown patch, turfgrass disease, damping off in seedlings, black scurf of potatoes, tomatoes, cabbage, bare patch of cereals, root rot of sugar beet, belly rot of cucumber, cacao fruit borer, brown plant hopper, vascular streak dieback, black pod rot, and sheath blight of rice. In another aspect, the plant is a cereal, and the cereal plant is treated for Rhizoctonia sp., including Rhizoctonia solani, with the composition include wheat, barley, canola, green pea, and seeds thereof. In another aspect, the seeds of the plant are treated with the composition during storage, prior to use, or when planted.

In another aspect, the composition is used to pre-treat and coat a seed of orange, grapefruit, lemon, lime, mandarin, Satsuma, kumquat, jojoba, apple, cocoa, coffee or other flowering plant. In another aspect, the method further comprises the step of adding to the whole leaf aloe vera extract at least one of a stabilizer, an anti-oxidant, a water-repellent, a UV absorbing agent, an anti-microbial agent, or combinations thereof. In another aspect, the whole leaf aloe vera extract is added to the plant growth medium or sprayed on the plant in situ. In another aspect, the whole leaf aloe vera extract is added to the plant growth medium or sprayed on the plant at 8, 16, 24, 32, 48, 72, 80, 88, 96, or 120 liters per 10,000 m². In another aspect, the aloe vera gel comprises an aloin content at least 600, 800, 1,000, 2000, 10,000, 25,000, 50,000, or even 100,000 ppm or more. In another aspect, the increase plant growth or yield is achieved without the addition of pesticides or insecticides. In another aspect, the aloe vera gel and aloin are not insecticidal, but rather, repel the insects. In another aspect, the plant comprises a grass, a grain, a fruit or a vegetable. In another aspect, the whole leaf aloe vera extract is diluted to 20, 16, 15, 10, 9, 8, 7, 6, 5, 4, 3, 2, or 1% in a plant growth media or water prior to use. In another aspect, the plant growth media is selected from at least one of soil, nutrient enhanced soil, an in vitro growth media, hydroponic growth media, or agar growth media. In another aspect, the method further comprises reducing the amount of plant nutrients by 75, 50, or 25%, while still observing an increase in plant growth or yield. In another aspect, the method further comprises isolating an aloe vera gel that comprises between 2.0 to 7.5% weight/volume solids, gibberellic acid, and aloe vera lignins. In another aspect, the composition is used to treat Brown patch, turfgrass disease, damping off in seedlings, black scurf of potatoes, tomatoes, cabbage, bare patch of cereals, root rot of sugar beet, belly rot of cucumber, cacao fruit borer, brown plant hopper, vascular streak dieback, black pod rot, and sheath blight of rice.

In one embodiment, the present invention includes a composition for treating one or more pathogens that affect plants comprising: an isolated whole leaf aloe vera extract, wherein the aloe vera leaf is processed to eliminate solids and to preserve the gel of the aloe vera gel and may further maintain or include additional aloin; and at least one of diluting the whole leaf aloe vera extract and spraying the whole leaf aloe vera extract on the plants, wherein the aloe vera gel and aloin at least one of stop the growth of, reduce the spread of, or kill the one or more pathogens. In another aspect, the aloe vera gel is concentrated, lyophilized, liquid, or gel. In another aspect, the composition further comprises at least one of a stabilizer, an anti-oxidant, a water-repellent, a UV absorbing agent, an anti-microbial agent, or combinations thereof. In another aspect, the aloe vera gel is dried, ground, whole or concentrated. In another aspect, the composition is at least one of repelling insects or pests without the addition of additional insecticides or pesticides. In another aspect, the composition is used to treat Brown patch, turfgrass disease, damping off in seedlings, black scurf of potatoes, tomatoes, cabbage, bare patch of cereals, root rot of sugar beet, belly rot of cucumber, cacao fruit borer, brown plant hopper, vascular streak dieback, black pod rot, and sheath blight of rice.

In another aspect, the plant is orange, grapefruit, apples, cocoa, coffee or other flowering plant. In another aspect, the composition increased leaf greenness (SPAD), and showed a significant gain in net photosynthesis (PN). In another aspect, the composition is used to treat Brown patch, turfgrass disease, damping off in seedlings, black scurf of potatoes, tomatoes, cabbage, bare patch of cereals, root rot of sugar beet, belly rot of cucumber, cacao fruit borer, brown plant hopper, vascular streak dieback, black pod rot, and sheath blight of rice. In another aspect, the plant is a cereal, and the cereal plant is treated for Rhizoctonia sp., including Rhizoctonia solani, with the composition include wheat, barley, canola, green pea, and seeds thereof. In another aspect, the seeds of the plant are treated with the composition during storage, prior to use, or when planted. In another aspect, the composition is used to pre-treat and coat a seed of an orange, grapefruit, lemon, lime, mandarin, Satsuma, kumquat, jojoba, apple, cocoa, coffee or other flowering plant. In another aspect, the composition is defined further as comprising aloe vera gel that comprises between 2.0 to 7.5% weight/volume solids, gibberellic acid, and aloe vera lignins.

### BRIEF DESCRIPTION OF THE DRAWINGS

For a more complete understanding of the features and advantages of the present invention, reference is now made to the detailed description of the invention along with the accompanying figures and in which:

FIG. 1 shows the effects of Coats AgriAloe GroAloe concentration on the growth of mycelium of strains TX-RS1 and TX-RS12 of R. solani. Marked contours are for easy visualization of colonies.

FIGS. 2A and 2B show the effects of Coats AgriAloe GroAloe concentration on the growth of mycelium of strains TX-RS1 (FIG. 2A) and TX-RS12 (FIG. 2B) of R. solani.

FIGS. 3A and 3B show the effects of Coats AgriAloe GroAloe concentration on the mycelium growth from germinated sclerotia of strains TX-RS1 and TX-RS12 of R. solani. Marked contours are for easy visualization of colonies.

FIGS. 4A and 4B show the effects of Coats AgriAloe GroAloe concentration on the mycelium growth from germinated sclerotia of strains TX-RS1 (FIG. 4A) and TX-RS12 (FIG. 4B) of R. solani.

FIGS. 5 and 6 are photographs of the untreated cacao plants and fruit prior to treatment with the present invention.

FIGS. 7, 8 and 9 are photographs of the cacao plants and fruit after treatment with the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Aloe vera, a tropical or subtropical plant of the genus Aloe has lance shaped leaves which contain a viscous but essentially clear gel which is given structural rigidity by hair-like connective fibers that run through it. The clear gel of the aloe vera is to be distinguished from the thick, mucilaginous yellow juice that occurs about the base of the plant leaves and adjacent the rind of the leaf. This juice, known as aloin, has been used for many years as an ingredient in many cathartics and purges. The aloin component of aloe vera includes, generally, several anthraquinones. The anthraquinones for use with the present invention may includes those from aloe, senna, rhubarb, and Cascara buckthorn, fungi, lichens, and insects.

Advantages of Coats AgriAloe application. Aloe vera has shown in extensive laboratory studies to kill all bacteria, virus, fungus, yeast and mold it has been tested against. Importantly, after soaking the fruit, grain, grass, or vegetable in a solution of GroAloe (GroAloe is water soluble) it can be rinsed off the fruit, grain, grass, or vegetable with no side effects or toxicity. The present invention has a variety of uses, including: (1) increased moisture and nutrient uptake; (2) repels insects; (3) laboratory tested ability to kill bacteria, mold, yeast and fungus; (4) increase photosynthesis; (5) increase in plant production; (6) has no known toxicity after washing the plants, fruits, grasses or vegetables; and/or (7) does not harm the environment.

It is known that the therapeutic qualities of the clear gel of aloe vera leaves depend to a large extent on the freshness of the gel. For example, the pain of a jelly fish sting may be stopped not to recur by applying the clear gel from a leaf that has just been cut, but if the gel has been exposed to air and light for about one and a half hours, these powers are greatly diminished, if not lost. In some cases, however, relatively old unstabilized gel has been found to be effective and apparently the varying efficacy of a fresh gel for different medicinal purposes reflects the fact that the gel is a complex mixture of substances whose natural stability on exposure to air and light at different temperatures differ from batch to batch.

The raw material for preparing the cold process stabilized aloe vera gel (referred to GroAloe) is obtained from the leaves of fully mature aloe vera plants. For example, four to five year old plants are used to ensure full maturity to obtain a higher quality of leaves containing a larger amount of gel. The plants are grown under controlled conditions so that the size and structure of the leaves are more uniform, enabling accurate measurement and selection of quantities of materials to be used in the purification process.

Aloe vera leaves are processed as soon as possible after cutting from the plant. Immediate processing of the aloe vera leaves prevents degradative decomposition of the gel material as possible, which begins upon cutting due to natural enzymatic reactions as well as growth of bacteria within the gel due to the presence of oxygen. After cutting, the aloe vera leaves are washed in water or a water and detergent mixture. The leaves are then washed with a suitable bactericide and fungicide. For example, the leaves can be soaked in a water and chlorine solution for about 5 to 10 minutes, rinsed with sterilized water, and dried to limit any lint on the leaves.

The aloe vera gel is separated from the leaf by first slicing and grinding the leaves. The most common method of removing the gel from the rind is the hand-fillet method, although semi-automated and automated methods also exist. Any grinder known in the aloe vera art can be used. The clear aloe vera gel is then ground to form a gel that includes aloin. Often, the gel will include a solid phase or reticle, which is known as the leaf pulp. It has been found that any finisher known in the aloe vera arts can be used to separate the pure gel from the pulp.

Briefly, the ground leaf mixture is fed into the finishing cavity, which is a space created by a spiral with specially designed flights and contained inside are a plurality of 360 degree cylindrical screens having openings on the order of one-quarter of an inch in diameter, to remove the large green pulpy portions, and ending with one having an opening on the order of 0.5 microns in diameter. As the spiral rotates, the more liquid phase of the ground leaf mixture is separated from the solid phase as the liquid phase migrates toward the area outside the screen. Once through the screen, the liquid phase flows into, e.g., a fully enclosed stainless steel pan. At this point, the aloe vera gel extract is generally clear yellow color in appearance. The yellow color is due to the presence of the aloin in the aloe vera mixture. Once separated from the liquid phase, the solid phase of the ground leaf mixture is discarded. This aloe vera gel is referred to herein as GroAloe. When the GroAloe is enhanced with aloin it is referred to herein as Coats AgriAloe. Coats AgriAloe is enhanced to increase the anthraquinone activity, thus increasing the beneficial effects on plants, including but not limited to, repelling the insects and not killing them with poisons that are detrimental to the environment and humans. Coats AgriAloe also enhances the physiological aspects of the plant by having enhanced anti-bacterial and/or fungicidal properties. Coats AgriAloe can also be enhanced with additional Gibberellic acid, which is a natural plant growth hormone. Aloe vera is high in gibberellic acid, this is essential in obtaining optimal plant growth. Aloe vera also contains Lignins. Aloe vera lignins are another compound found in Aloe Vera. The Coats AgriAloe process helps maintain the Aloe vera lignin, which have the ability to penetrate and act as a carrier for the Gibberellic Acid and the Anthraquinones in Coats AgriAloe. The Aloe vera lignin helps plants to absorb more nutrients from the soil much quicker and efficiently. Finally, it has been found that the aloin-enhanced, aloe vera extract of the present invention, when sprayed at 1 to 20% volume to volume (in certain cases, 2, 3, 4, 5, 6, 7, 8, 9, 10, 12, 15, 16, 18, or 20%), or 1 to 20% weight to volume (in certain cases, 2, 3, 4, 5, 6, 7, 8, 9, 10, 12, 15, 16, 18, or 20%) if the Coats AgriAloe has been dried, into the leaves of the plant enhances the plant's ability to photosynthesize.

Furthermore, the aloin-enhanced, aloe vera gel can be an organically grown product, it is safe for use in areas where chemical insecticides cannot be used, it has shown no toxicity to the environment, causes a large increase in production from plants due to elimination of damage done to plants by insects, and has no reported toxicity to animals that may come in contact with plants sprayed with aloin-enhanced, aloe vera gel.

When the entire leaf is used to obtain the aloe vera gel extract, it is commonly referred to as whole leaf aloe vera gel or whole leaf aloe vera extract. When only the gel is obtained (and the leaves discarded), then it is referred to as aloe vera gel or filet. The whole leaf or the aloe vera gel extracts isolated as described hereinabove can be used in the present invention without further processing due to the presence of the aloin in the isolated gel or extract. However, it has been found that the addition of aloin (anthraquinones) enhances the composition. For ease of transportation, it is possible to keep the gel in its original form, convert it into a dry, ground, freeze-dried, heat dried, vacuum dried, air-dried, spray-dried aloe vera gel (or combinations thereof). The aloe vera extract may also include one or more of a stabilizer, an anti-oxidant, a water-repellent, a UV absorbing agent, an anti-microbial agent, or combinations thereof. Often, the aloe vera gel or extract can be used in the plant growth medium or sprayed on the plant at 8, 16, 24, 32, 48, 72, 80, 88, 96, or 120 liters per 10,000 m². For example, mature plants are used to obtain a higher quality of leaves containing a larger amount of gel.

To the extent necessary, removal of bacteria, fungi and other organisms from the aloe vera leaf can be accomplished by using a combination of methods to assure that all bacteria are removed. This can include the use of chemical compounds such as glucose oxidase, boiling, ultraviolet light and the use of bacteria removing filters. In some embodiments, the aloe gel may also include additives or preservatives, e.g., sodium benzoate may be added in sufficient quantities to obtain a 0.1% solution of sodium benzoate in the final mixture. Another example of an additive may be a 0.1% solution of glucose oxidase/catalase. After addition of the additives, these may be incorporated into the gel using a mixer or blender and the components are mixed thoroughly for about 10 minutes. The gel is then allowed to sit for approximately 1 hour. To the extent needed, enough citric acid or other acid may be added to the gel to adjust the pH.

After treatment in this manner, the aloe vera composition may be concentrated by lyophilization with liquid nitrogen to a predetermined concentrate volume, if desired. It may then be transferred to amber bottles and kept in a cool place for future use. Or, as an alternative, it may be stored without such concentration in plastic-lined barrels.

The following example is set forth for the purpose of illustrating one embodiment of the present invention and is not to be interpreted as a limitation thereof or in any limiting fashion.

Sheath blight, caused by the fungus Rhizoctonia solani AG1-IA, is the most important disease in rice in the US and is one of the most important diseases in other rice-producing countries. The disease causes significant losses in grain yield and quality each year. Sheath blight can cause as much as 50% yield loss. None of the commercially available rice cultivars have acceptable levels of resistance against sheath blight. Rice farmers heavily depend on fungicides for control of the disease. Excessive use of fungicides have caused fungicide resistance and increased production costs. Farmers are in need of alternative and sustainable strategies for control of sheath blight. Objective of this research was to evaluate the efficacy of Coats AgriAloe for control of R. solani in an effort to develop a novel biocontrol approach for management of sheath blight and improvement of grain yield in rice.

Experiments were conducted in the lab to evaluate the effects of Coats AgriAloe on the mycelium growth of R. solani and on the germination of sclerotia and the mycelium growth from germinated sclerotia. Sclerotia and mycelium in infected residue are the primary inoculum inducing disease development at the beginning of disease cycle. Runner hyphae (mycelium) are the only means for this fungus to infect and spread the disease during the cropping season. Control of mycelium growth and sclerotium germination is the key to the effective management of sheath blight.

It was found that foliar sprays of Coats AgriAloe provide significant control of narrow brown leaf spot. The inhibition of spore germination of the pathogen by Coats AgriAloe is one of the mechanisms associated with Coats AgriAloe-induced disease suppression. More studies are needed to verify the results of this study in the future. It would be very interesting to conduct field and lab experiments to determine if Coats AgriAloe can also control sheath blight caused by the fungus Rhizoctonia solani, the most important disease in the US and the world. Proved efficacy of Coats AgriAloe for control of sheath blight will significantly increase the marketability of this product domestically and internationally.

Effects of Coats AgriAloe on the Mycelium Growth of R. solani.

Two strains of R. solani, TX-RS1 and TX-RS12, were used in the experiment. Both pathogen strains were collected from rice plants showing symptoms of sheath blight in commercial rice fields in Texas. Each strain was grown on potato dextrose agar (PDA) plates at room temperature for 2 days before use. Briefly, PDA can be from a Potato infusion (boiling 200 grams of sliced (washed but unpeeled) potatoes in ˜1 liter) distilled water for 30 minutes and then decanting or straining the broth through cheesecloth). Distilled water is added to a total volume of the suspension is 1 liter, 20 grams (0.71 oz) dextrose, and 20 grams (0.71 oz) agar powder are added, the medium is sterilized by autoclaving, and the plates are prepared under sterile handling conditions. Coats AgriAloe in powder form was diluted in sterile distilled water and added into melted PDA medium to reach the concentrations of 4, 8 and 16% (v/v). PDA without Coats AgriAloe amendment served as the control (0%, v/v). Plugs (0.65 cm in diameter) of mycelium were cut from the edge of an actively growing fungal colony on PDA with a cork borer and one of the plugs was placed in the center of each PDA plate (10 cm in diameter). The plates were incubated at room temperature. After 24 hours of incubation, the diameter of the growth of mycelium from each of the plugs was measured. There were three replicates (plates) for each treatment. Each test was conducted two times.

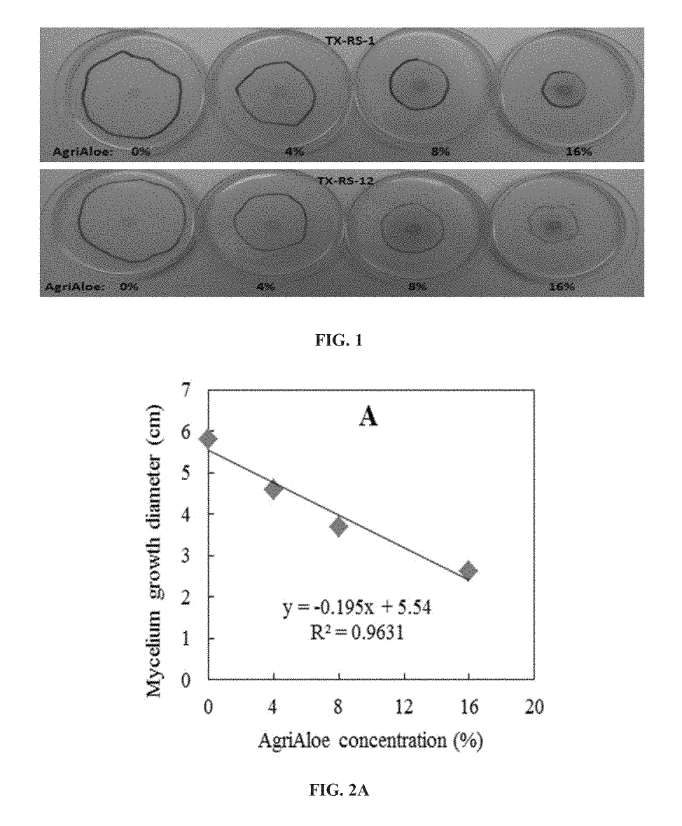

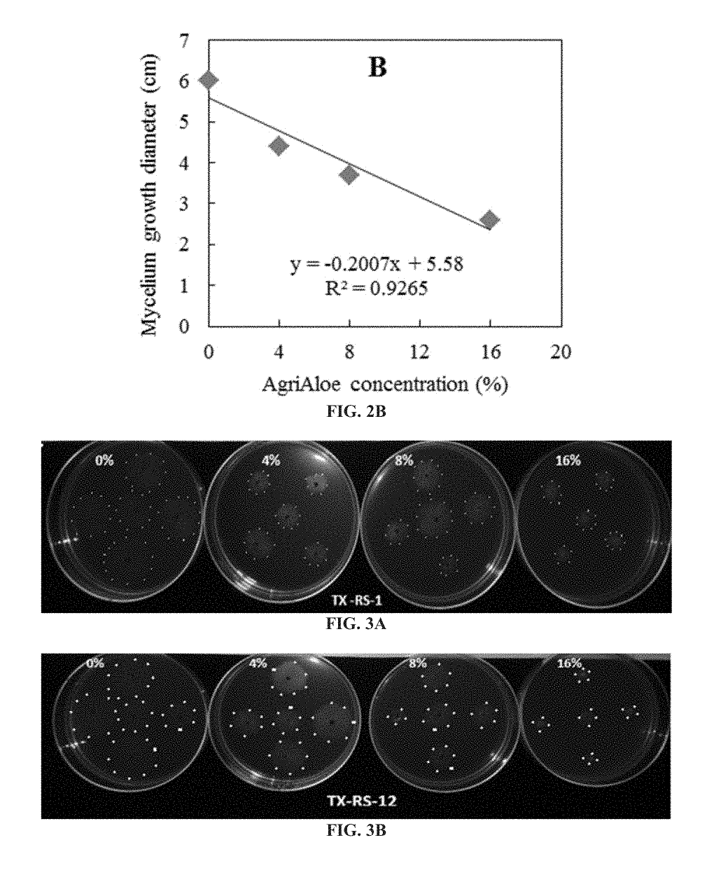

Coats AgriAloe applied at the concentrations of 4, 8 and 16% significantly inhibited the growth of mycelium of both isolates of R. solani evaluated (FIG. 1 and Table 1). The degree of mycelium growth inhibition linearly increased with the increase of concentration of Coats AgriAloe (FIGS. 2A and 2A). The mycelium growth inhibition efficacy reached more than 55% when the concentration increased to 16%.

TABLE 1
Effects of different concentrations of Coats AgriAloe
on the growth of mycelium of two strains of R. solani.

| AgriAloe | Mycelium growth | |
|---|---|---|
| concentration | diameter (cm) | |
| (%, v/v) | TX-RS1 | TX-RS12 |

| | | | | |
|---|---|---|---|---|
| 0 | 5.8 | a* | 6 | a |
| 4 | 4.6 | b | 4.4 | b |
| 8 | 3.7 | c | 3.7 | c |
| 16 | 2.6 | d | 2.6 | d |

*Means were the average of three replicated plates. Means within a column with the same letter are not significantly different (P = 0.05) according to Fisher's protected LSD test.

Effects of Coats AgriAloe on the Germination of Sclerotia and the Mycelium Growth from Germinated Sclerotia of R. solani.

Two strains of R. solani, TX-RS1 and TX-RS12, were also used in the study. Each strain was grown on Potato Dextrose Agar (PDA) plates at room temperature under the dark for four weeks to produce sclerotia. Uniform sclerotia in size and color were selected for the experiment. Coats AgriAloe in powdery formula was diluted in sterile distilled water and added into melted PDA medium to reach the concentrations of 4, 8 and 16% (v/v). PDA without Coats AgriAloe amendment served as the control (0%, v/v). Five sclerotia were placed evenly at distance on each PDA plate (10 cm in diameter) (FIGS. 3A and 3B). After 24 hours of incubation at room temperature, the number of sclerotia germinated on each plate was counted and converted to percent germination of sclerotia. The diameter of the mycelium growth from the germinated sclerotia was also measured for each colony. There were seven replicates (plates) for each treatment. The study was repeated twice.

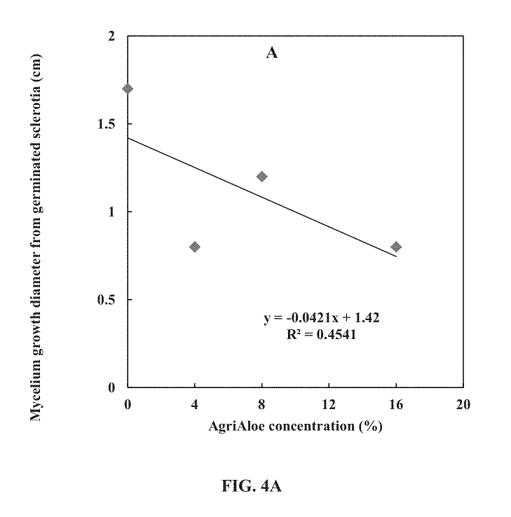

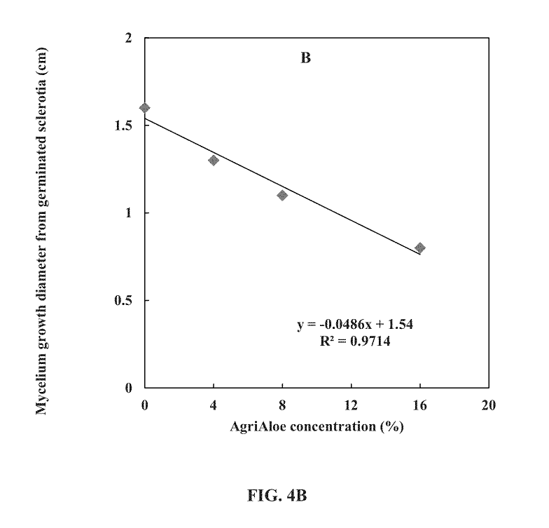

Coats AgriAloe applied at any of the concentrations (4, 8 and 16%) was not effective in reducing percent germination of sclerotia of either isolate of R. solani evaluated (Table 2). However, all the concentrations of Coats AgriAloe tested significantly reduced the mycelium growth from germinated sclerotia (FIGS. 3A and 3B, and Table 3). The degree of mycelium growth inhibition linearly increased with the increase of concentration of Coats AgriAloe (FIGS. 4A and 4B). The mycelium growth inhibition efficacy reached more than 50% when the concentration increased to 16%.

TABLE 2
Effects of different concentrations of Coats AgriAloe on
the germination of sclerotia of two strains of R. solani.

| AgriAloe | Germination | |
|---|---|---|
| concentration | of sclerotia (%) | |
| (%, v/v) | TX-RS1 | TX-RS12 |

| | | | | |
|---|---|---|---|---|
| 0 | 100 | a* | 94 | a |
| 4 | 100 | a | 94 | a |
| 8 | 100 | a | 100 | a |
| 16 | 100 | a | 86 | a |

*Means were the average of three replicated plates. Means within a column with the same letter are not significantly different (P = 0.05) according to Fisher's protected LSD test.

TABLE 3
Effects of different concentrations of Coats AgriAloe on the mycelium
growth from germinated sclerotia of two strains of R. solani.

| AgriAloe | Mycelium growth | |
|---|---|---|
| concentration | diameter (cm) | |
| (%, v/v) | TX-RS1 | TX-RS12 |

| | | | | |
|---|---|---|---|---|
| 0 | 1.7 | a* | 1.6 | a |
| 4 | 0.8 | c | 1.3 | b |
| 8 | 1.2 | b | 1.1 | b |
| 16 | 0.8 | c | 0.8 | c |

*Means were the average of three replicated plates. Means within a column with the same letter are not significantly different (P = 0.05) according to Fisher's protected LSD test.

Results of these studies demonstrate the ability of Coats AgriAloe composition to inhibit the growth of mycelium of the sheath blight pathogen. The Coats AgriAloe composition also showed the ability to reduce the mycelium growth from germinated sclerotia. The in vitro results indicate the effectiveness of Coats AgriAloe to control the sheath blight pathogen at the stages of primary and spread infection in actual field conditions.

Similar results have been obtained to treat blight in cocoa and coffee. Briefly, cocoa plants infected with Vascular-streak dieback (VSD) were identified and isolated. This disease is caused by the fungus known as Oncobasidium theobroma, and is responsible for heavy losses of trees in mature plantations. The disease has spread throughout South East Asia, causing major losses in large commercial plantations in Indonesia, Malaysia and Papua New Guinea. The infected cocoa plants were then exposed to a single treatment with differing dilutions of the aloin-enhanced aloe vera gel (Coats AgriAloe). It was found that a concentration as low as 6% Coats AgriAloe showed a significant reduction in plant blight, with complete elimination of the plant pathogen after 18 days using a 10% Coats AgriAloe solution.

Briefly, coffee plants infected with coffee leaf rust (CLR) were identified and isolated. Coffee leaf rust (CLR) is caused by the fungus Hemileia vastatrix, which has worldwide consequences. The infected coffee plants were then exposed to a single treatment with differing dilutions of the aloin-enhanced aloe vera gel (Coats AgriAloe). It was found that a concentration as low as 6% Coats AgriAloe showed a significant reduction in plant blight, with complete elimination of the plant pathogen after 18 days using a 10% Coats AgriAloe solution.

Sweet orange scab (SOS) is a disease caused by the fungus Elsinöe australis. This disease is named as it causes scab-like lesions that develop primarily on the fruit rind and infrequently, on leaves and twigs of orange, grapefruit, lemon, lime, mandarin, Satsuma, kumquat, jojoba, and other citrus trees. Although there is little effect on internal fruit quality, fruit are severely blemished rendering them unsellable in the fresh produce market. Further, the disease can cause premature fruit drop and stunt young nursery trees and new field plantings. If citrus disease were to spread out of control, it has the potential to destroy the entire U.S. citrus industry, causing the loss of billions of dollars and millions of jobs.

Recovery of E. australis from grapefruit fruits treated with 10% or 12% of AgriAloe for 2 or 3 minutes. Since these experiments were not repeated, data obtained should be considered as preliminary. However, it appears that AgriAloe has some antifungal properties against E. australis. Future studies with AgriAloe should include other products used by citrus organic packinghouses for comparison purposes.

TABLE 4
Recovery of E. australis from grapefruit fruits treated with 10% or 12% of
AgriAloe for 2 or 3 minutes.

| | | Number of | Fruits with |
|---|---|---|---|
| Treatment | Host | fruits tested | E. australis (%) |
| Control | Grapefruit | 360 | 44.2 a^{z} |
| AgriAloe 10% | Grapefruit | 360 | 35.3 b |
| AgriAloe 12% | Grapefruit | 360 | 34.7 b |

^{Z}Values with the same letter are not significantly different at P = 0.05.

Coats AgriAloe was shown to penetrate the tree and kill the fungus at tree level, and can also be used upon fruit arrival at, e.g., a processing or packing facility. To date, the aloin-enhanced, aloe vera gel of the present invention was able to control or destroy every fungal, bacterial and viral pathogen it has been tested against.

It was further found that the present invention had no detrimental effects on the plant, has significant effects on the plant pathogen, and also showed a significant increase in net photosynthesis. The adequacy of the time-of-day of application, namely application in low sun conditions (cloudy, early evening and night time) showed that Coats AgriAloe provided other benefits, such as the ability to repel insects, then these may be achieved without harm to the physiological status of the plant. The Coats AgriAloe composition and method of treatment had a positive benefit on physiological parameters related to photosynthetic ability, namely an apparent increase in leaf greenness (SPAD), which is associated with a significant gain in net photosynthesis (P_{N}). Foliar application of Coats AgriAloe was effective in reducing narrow brown leaf spot, one of the major diseases affecting rice production in Texas.

In summary, the Coats AgriAloe treatments did not have detrimental effects on the rice plant physiology, suggesting the adequacy of the time-of-day of application, and further suggesting that if Coats AgriAloe provides other benefits, such as repellant ability, then these may be achieved without harm to the physiological status of the plant. Furthermore, the data show a positive benefit on physiological parameters related to photosynthetic ability, namely an increase in leaf greenness, which potentially carried over as possible benefits in several other photosynthetic parameters.

Pre-soaking seeds. It was found that pre-soaking the seeds for a specific time in a diluted solution of Agri-Aloe they were able to not only give the seed a protective barrier, but were also able to see a 10% increase in production. They also tested the Agri-Aloe composition on rice paddies that were infected with Narrow Leaf Brown Spot (NLBS). NLBS is a devastating crop disease seen throughout the world but is more prominent in the Americas. The Agri-Aloe composition proved effective in controlling this disease.

Having shown remarkable results attacking NLBS, the Agri-Aloe composition was used to performed tests using Agri-Aloe as treatment for Sheath Blight. Sheath Blight is the number one disease globally that effects as much as 50% of the world's rice production. Sheath Blight (Rhizoctonia Solani) is a fungus. Three tests were conducted, first a basic field-test, next in depth in vitro tests, followed by more extensive field-testing. It was found that the Agri-Aloe composition effectively inhibited the spore germination of this fungus. As mentioned earlier, with up to 50% of the world's rice production being lost to this fungus currently there is not an effective control for this disease.

Furthermore, it has been found that depending on the amount of sunlight, humidity, and location the composition is more effective when used following methods and mixing ratios.

For Kilo of Coats AgriAloe: Mix 1 kilo with 82.560 gallons of water for a 10% solution. This is enough finished product to spray 1 Hectare 0.891 times. Mix 1 Kilo Coats AgriAloe with 165.125 gallons of water for an 8% solution. This is enough finished product to spray 1 Hectare 1.782 times. Mix 1 Kilo with 240.750 gallons of water for a 6% solution. This is enough finished product to spray 1 Hectare 2.599 times. Mix 1 Kilo with 330.250 gallons of water for a 4% solution. This is enough finished product to spray 1 Hectare 3.565 times. A single Hectare is the equivalent of 2.471 acres.

For 100 gram packets of Coats AgriAloe: Mix 100 gr packet with 8.25 gallons of water for a 10% finished solution. Mix 100 gr packet with 16.50 gallons of water for an 8% finished solution. Mix 100 gr packet with 24.75 gallons of water for a 6% finished solution. Mix 100 gr packet with 33.25 gallons of water for a 4% finished solution.

Generally, the Coats AgriAloe should be applied at a rate no higher than 8% dilution for best general results. Never apply Coats AgriAloe to tender seedlings. Serious crop damage can occur if foliage is too young. Never apply Coats AgriAloe in direct sun light; it should only be applied at Dusk or after Sun Set. Always shake Coats AgriAloe thoroughly before use. Store Coats AgriAloe in a dry ventilated area between 40° and 90° F. (4.5° C. to 32.2° C.). Always were protective rubber gloves and protective mask when mixing GroAloe Powder. It is not recommended to apply GroAloe over a percentage of 8% in tropical climates.

These examples demonstrate that the present invention has a variety of uses, including: (1) increased moisture and nutrient uptake; (2) repels insects; (3) laboratory tested ability to kill bacteria, mold, yeast and fungus; (4) increase photosynthesis; (5) increase in plant production; (6) has no known toxicity after washing the plants, fruits, grasses or vegetables; and/or (7) does not harm the environment.

Control of Cacao Vascular Streak Dieback and Black Pod Rot Diseases.

Insects and fungi are noxious to agricultural crops. Vector insects carry fungi and virus and spread them around to healthy and productive plants and created massive damages as those healthy plants are dying and become unproductive. It was found that GroAloe has the ability to control fungi and repels insects—the major cause to agricultural problems. It was found that, GroAloe acts as an insect repellent and fungicide to protect Cacao crops. These are two critical functions of GroAloe needed to help farmers back to their production line of Cacao.

This example shows the use of GroAloe on Cacao crop (Theobroma cacao) to control two most damaging Cacao diseases Vascular Streak Dieback (VSD) and Black Pod Rot (BPR) in Poliwali Mandar Regency (District) of West Sulawesi, Indonesia and the results of this GroAloe application along with my analysis of the results recorded earlier.

Massive Cacao Damages due to VSD and BPR Attacks. Indonesia Cacao production has been reported to drop by an average of 50% due to VSD and BPR attacks. West Sulawesi province, the main Indonesia's Cacao production area, these diseases have caused damages as high as 90% of Cacao production. There are 172,258 hectares Cacao production in West Sulawesi, the production level of Cacao in West Sulawesi has seriously declined from the country's top Cacao production to almost nothing.

Government intervention to control these Cacao diseases has not given significant results. Government effort to overcome the Cacao major diseases that are rampant among the smallholder Cacao plantations is done primarily by providing farmers with Cacao clones that are resistant to these noxious fungi diseases. Farmers, on the other hand, are reluctant to replant their Cacao garden as they are afraid of these VSD and BPR diseases will keep on coming back. Many farmers almost give up doing anything to their Cacao garden. This attitude makes the situation worse because unattended, unmaintained Cacao garden beside they become unproductive, they also turn to permanent home of these diseases, just another step to make these disease become endemic to this area.

Indonesia owns 1,704,982 Hectares Cacao plantations of which 1.622.600 Hectares owned and controlled by smallholders (Perkebunan Rakyat), 39.127 Hectares owned by the State Plantation Companies and 43.255 Hectares owned by Private Companies. Out of 1.622.600 Hectares of Smallholder Cacao gardens only 641,997 Hectares are productive, this brings to only about 48% of Cacao gardens managed by the farmers, only less than 50% are productive; this contrasts to State owned 72% Cacao Plantation are productive and 71% of Privately owned Cacao Plantations are productive.

Outside of Indonesia, impacts of BPR disease of cocoa in West Africa, caused almost exclusively by Phytophtora megakarya, still remains one of the most serious constraints on cocoa production. Surveys during the 1978 and 1979 harvest season in Togo revealed losses of up to 80%, when no control measures were taken (Djiekpor et al., 1981). Erwin and Ribeiro (1996) estimated a 20-30% loss of the world's cocoa crop to black pod, and in some areas they estimated that 90-95% of the crop is rendered unusable.

There are two main diseases that attack Cacao plants (Theobroma cacao) in Indonesia and around the world causing much of the damages to Cacao production.

One is Vascular Streak Dieback (VSD) caused by Oncobasidium theobromae a fungus invested along the cambium of Cacao plants indicated by the brown streak line along the twigs and later to the main trunk of the cacao plants, at the later stage it develop canker. Infected plants leaves turn yellow then brown and later fall off; their twigs dried out and died. VSD is a dieback disease that cause major damages and could potentially wipe out Cacao population.

The other is Black Pod Rot (BPR) disease caused by Phytophthora fungi family, mycologists characterize the four main species that infect cacao they are P. palmivora, P. megakarya, P. capsicidan P. citrophthora. BPR causes Cacao healthy fruits to rot from outside in; BPR attacks Cacao fruits from young and small to ripen and big with damage level varied from the length of the attack and degree of resistance of the Cacao cultivar planted. BPR can easily spread to Cacao's healthy fruits by the vector insects from Helopeltis sp. As these vector insects suck liquid sap from healthy fruits, at the same time, they deliver a fungus inoculum in the process. Other insect pests that also become vector of BPR help spread the disease to surrounding Cacao plantations is Cacao Fruit Borer (CFB) insect i.e. Conopomorpha cramerella Snell. (Lepidoptera; Gracillariidae). These insects bore all stages of Cacao fruits and inject the damaging fungi inoculum into the fruits at all stages of fruit growth.

The following are symptoms of Black Pod Rot disease:
1. Fruits—lesions: black or brown
2. Fruits—mummification
3. Fruits—premature drop
4. Roots—soft rot of cortex
5. Seeds—rot
6. Seeds—shriveled
7. Stems—canker on woody stem
8. Whole plant—damping off
9. Whole plant—plant dead; dieback

GroAloe was able to organically and systemically control fungus and many other pests in Demonstration Plots in four locations of Poliwali Mandar (Polman) Regency (Kabupaten) of West Sulawesi province.
1. In Landi Kanusuang Village, District Mapilli—Polewali Mandar, 50 plants were chosen to receive GroAloe treatment. Cacao plants were are 4 years old.
2. In another part of Landi Kanusuang Village, District Mapilli—Polewali Mandar, were 50 plants were chosen to receive GroAloe treatment. Cacao plants were are 6 to 10 years of age.
3. In the Patampanua Village, Matakali District—Poliwali Mandar, 50 plants were chosen to receive GroAloe treatment. Cacao plants were are 6 to 10 years old.
4. In Rappang Village, District Tapango—Poliwali Mandar, 50 plants were chosen to receive GroAloe treatment. Cacao plants here were 6 to 10 years of age.

The GroAloe Application Procedures. GroAloe was applied to cacao plants in Polman, West Sulawesi to show GroAloe ability to organically and systemically control VSD and BPR diseases that attacks Cacao plants. The application procedures of GroAloe were selected to control the most fatal fungi attack that cause fruits production damages to Cacao plants. Three applications of GroAloe were used to these Demonstration plot sites. GroAloe powder was used in these applications. Powder was mixed with water to reach the appropriated level of percentage spraying liquids, as described hereinabove. GroAloe applications were done by spraying with two weeks intervals. Spraying were made during late afternoon around 16:00 hours and up. Manual spraying tools were used and locally made of the well-known brand and familiar to Cocoa farmers in this area to mimic actual use conditions. There were three applications made to these four selected sites with 50 selected Cacao plants during this demonstration period. These plants were marked with plastic laminated sign to record and follow on the results of this GroAloe applications. The application procedure was as follows:

First application was done with 8% concentration applied by spraying on the leaves trunks and twigs and on the soil. Application of 8% GroAloe is a recommended dilution for GroAloe application. The significant indication is the coming out of the leaves buds and the livelier color of the leaves after the first treatment of GroAloe. Cacao leaves look more shinny.

Second application was done one month after the first application with 6% concentration. GroAloe application made by spraying on the leaves trunks and twigs and some on the soil. This percentage reduction to 6% because there were some significant improvement of the Cacao plants.

Third application was done in January 2016, also with 6% concentration applied on the leaves trunks and twigs and on the soil. Cacao plants response to GroAloe application was fast. Immediate results after the third application of GroAloe the Cacao crops produced abundant flowers.

Spraying applications of GroAloe were done by hiring local farmers and supervised by trained personnel and a Government Official from GerNas Program (Cacao Production Increase Program). By mid-January GroAloe application had completed the Demonstration Plot in four locations in Polman, West Sulawesi; the followings are the results:

1. Significant improvements were visible right after three days after the first GroAloe application. Most wilting plant, if not all, showed signs of revival, new leave buds began sprouting from the presumed dead twigs. The leaves color more shinny and leaves looks healthy. The improvement in appearance was clearly visible after the first GroAloe treatment.

2. After the second application two-three weeks later, flower buds started to come out more abundantly than what farmers have seen before. Cacao flowers are mainly located in the trunk and bigger branches of the plant, Cacao flowers came out after their leaves turn green. One significant sign that Cacao plant began to revive and healthy again, their leaves turn to yellowish green and shiny.

3. Flowers made to young fruit buds and the healthy fruits were in the making.

4. Healthy fruits become big and ripen. When these fruit were opened farmers found healthy and moist seeds inside these Cacao fruits.

5. The average fruits produced by these Demonstration Plots trees were 20 Big and healthy fruits. But some of the bigger trees they produced about 40 healthy and good yielding fruits. Some even collected 150 fruits from only one tree.

6. Amazingly, after the first harvest, these Cacao trees started new flowers again and produce more of healthy Cacao fruits; and from the second harvest, farmers collect more abundantly healthy Cacao fruit than the first harvest.

7. Eight months later, the smallholder farmers' Cacao garden in Poliwali Mandar whom participated in the Demonstration Plot show continued growth of their cacao plants. One cacao farmer reported that some of his Cacao Trees were able to give about 200 big and healthy Cacao fruits.

8. Farmers using GroAloe were able to use existing equipment and techniques to deliver the GroAloe without the need for harsh, expensive, and tons or larger quantities of pesticides, but rather used aloin that after treatment measured in Part per Million (PPM); In Cacao 1 KG of GroAloe powder was sufficient for providing protection and food for one hectare Cacao crop for one cropping season.

9. GroAloe repels insects, especially vector insects that carry damaging diseases. This is especially true for BPR cases that show the vector insects of Helopeltis sp. It was found that these vector insects did not like to suck juice from the Cacao fruits treated with GroAloe.

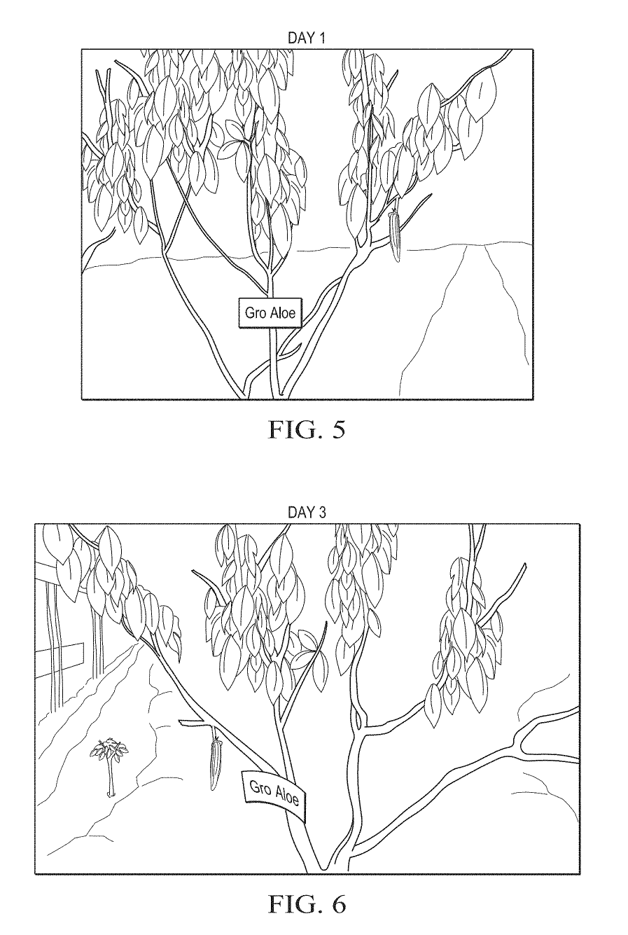

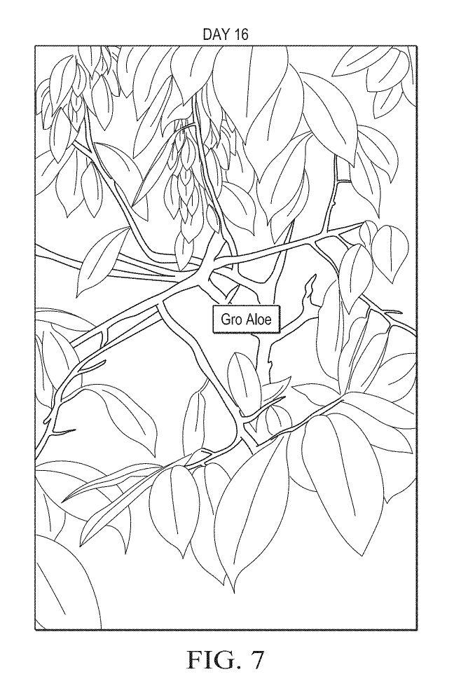

FIGS. 5 and 6 are photographs of the untreated cacao plants and fruit prior to treatment with the present invention. These photographs show the poor condition of the leaves of the cacao plant and the shriveled fruit caused by a fungal infection.

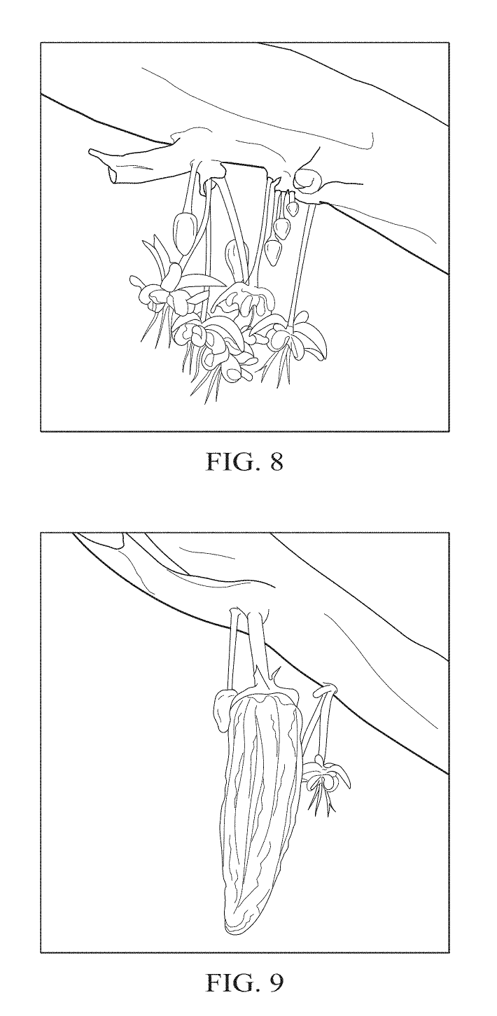

FIGS. 7, 8 and 9 are photographs of the cacao plants and fruit after treatment with the present invention. FIG. 7 shows that the leaves of the treated cacao plant are now full and the overall plant has a growing number of healthy leaves. FIG. 8 is a close-up view of the treated cacao plant that has overcome the fungal infection and is beginning to again flower. FIG. 9 is a close-up of the cacao fruit of a cacao plant treated with the present invention. The cacao fruit grew from the flowering cacao plant (as shown in FIG. 8) and is healthy and on the way to be ready to harvest, thereby demonstrating the long-term effect of the composition and method of treatment of the present invention.

The followings are the conclusion from the treatment of the Demonstration Plots of Cacao with GroAloe in Poliwali Mandar (PoiMan) District of West Sulawesi. It was found that GroAloe repairs soil ecology especially if applied on soils died due to over use of chemical applications. In Cacao during the first, second and third application Cacao soil was sprayed until it became wet. Soil improvement results of GroAloe can be seen more clearly in rice paddy—my other GroAloe treatment observation—where only after 3 GroAloe applications, earth worms come out by so many. Worm's mucus has high contain of C-organic.

GroAloe is capable to control Fungi that caused Vascular Streak Dieback (VSD) and Black Pod Rot (BPR). GroAloe contains anti-fungi property that kills the Oncobasidium theobromae and Phytophthora palmivora and other Phytophthora species; these fungi kill the Cacao Plant. Lignin in GroAloe carries this Anti-fungi agent and cures the damaging effects caused by the fungi.

GroAloe stimulate new growth of the Cacao plants; three days after GroAloe treatment, new leave buds came out abundantly.

It was found also found that GroAloe triggers the production of Florigen an internally produced hormone that made flowers to come out and generate fruits. This explains why among GroAloe treated Cacao plants, flowers come out abundantly, not only once but they keep on coming and gave abundant harvest repeatedly. One farmer reported that he collected 3 time harvests after his Cacao plants were cured from VSD and BPR diseases.

GroAloe controlled the fungi that attacked the Cacao crop. The high contain of Lignin assures that the fungi-controlling agent of GroAloe transported and spread fast in clearing the diseases like VSD and BPR. These demonstration plots showed GroAloe is able to control fungi (Oncobasidium and Phytophthora) that caused major damages on Cacao. On rice crop, GroAloe controlled Bias fungus (Pyricularia grisea) a serious harvest risk on rice. Farmers can easily lose their harvest due to the Bias fungus attack.

GroAloe was also able to repel insects, in Cacao, the Cacao Fruit Borer (CFB) insects, in Rice Brown Plant Hopper (Nilaparvata lugens), Rice Bugs (Oratorius leptocorisa), White Butterflies (Tryporiza innotata) and many other don't like to be around the crops sprayed with GroAloe.

It was also found that GroAloe triggered an increase in the total number of cacao fruits. Gibberellin is fruiting trigger agent of GroAloe that initiated the internal Florigen that makes flowers to come out. Flowers become fruits and fruits grow healthy through maturity and bring farmers abundant harvests. GroAloe also contains high degree of Potassium also called Kalium (K). This high “K” contains of GroAloe triggers the flowering of the fruiting plants. In Cacao it triggers the generation of flowers and the formation of fruits. “K” combined with Gibberellin help to produce big and healthy fruits. What is true for Cacao is also true for many other fruiting plants. In combination with GroAloe ability to control fungi, these Cacao plants are able to produce healthy fruits abundantly and continuously. The exiting many—post GroAloe treatment—from a Cacao farmer in Village of Patampanua in Polman that he has collected three continues abundant harvest of his Cacao plants received during demonstration plots exercise in his Cacao garden.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A method for treating one or more pathogens that affect plants comprising:
identifying a plant or seed in need of treatment of a plant;
obtaining a whole leaf aloe vera extract and adding aloin in an amount sufficient to stop the growth of, reduce the spread of, or kill the one or more pathogens on the plant or reduce the amount of infected plants that arises from the treatment of seeds, wherein the aloe vera leaf is processed to eliminate solids and to preserve the gel of the aloe vera gel; and
at least one of diluting the whole leaf aloe vera extract and spraying the whole leaf aloe vera extract on the plant or seed, wherein the aloe vera gel and aloin at least one of stop the growth of, reduce the spread of, or kill the one or more pathogens on the plant or reduce the amount of infected plants that arises from the treatment of seeds.

2. The method of claim 1, wherein the method further comprises the step of processing the aloe vera into a liquid, a gel, is dry, is ground, is freeze-dried, heat dried, vacuum dried, air-dried, spray-dried, or combinations thereof.

3. The method of claim 1, wherein the plant treated comprises a grass, a grain, a fruit or a vegetable.

4. The method of claim 1, wherein the whole leaf aloe vera extract is diluted to 20, 15, 10, 9, 8, 7, 6, 5, 4, 3, 2, or 1% in a plant growth media or water prior to use on the plant or seed.

5. The method of claim 1, wherein the plant is orange, grapefruit, lemon, lime, mandarin, Satsuma, kumquat, jojoba, apple, cocoa, coffee or other flowering plant.

6. The method of claim 1, wherein the composition increased leaf greenness (SPAD), and showed a significant gain in net photosynthesis (P_{N}).

7. The method of claim 1, wherein the composition is used to treat Brown patch, turfgrass disease, damping off in seedlings, black scurf of potatoes, tomatoes, cabbage, bare patch of cereals, root rot of sugar beet, belly rot of cucumber, cacao fruit borer, brown plant hopper, vascular streak dieback, black pod rot, and sheath blight of rice.

8. The method of claim 1, wherein the plant is a cereal, and the cereal plant is treated for Rhizoctonia sp., including Rhizoctonia solani, with the composition include wheat, barley, canola, green pea, and seeds thereof.

9. The method of claim 1, wherein the seeds of the plant are treated with the composition during storage, prior to use, or when planted.

10. The method of claim 1, wherein the composition is used to pre-treat seeds of orange, grapefruit, lemon, lime, mandarin, Satsuma, kumquat, jojoba, apple, cocoa, cacao, coffee or other flowering plant.

11. The method of claim 1, further comprising adding to the whole leaf aloe vera extract at least one of a stabilizer, an anti-oxidant, a water-repellent, a UV absorbing agent, an anti-microbial agent, or combinations thereof.

12. The method of claim 1, wherein the whole leaf aloe vera extract is added to the plant growth medium or sprayed on the plant in situ.

13. The method of claim 1, wherein the whole leaf aloe vera extract is added to the plant growth medium or sprayed on the plant at 8, 16, 24, 32, 48, 72, 80, 88, 96, or 120 liters per 10,000 m².

14. The method of claim 1, wherein the aloe vera gel comprises an aloin content at least 600, 800, 1,000, 2000, 10,000, 25,000, 50,000, or even 100,000 ppm or more.

15. The method of claim 1, wherein the increase plant growth or yield is achieved without the addition of pesticides or insecticides.

16. The method of claim 1, wherein the plant comprises a grass, a grain, a fruit or a vegetable.

17. The method of claim 1, wherein the whole leaf aloe vera extract is diluted to 20, 16, 15, 10, 9, 8, 7, 6, 5, 4, 3, 2, or 1% in a plant growth media or water prior to use.

18. The method of claim 1, wherein the plant growth media is selected from at least one of soil, nutrient enhanced soil, an in vitro growth media, hydroponic growth media, or agar growth media.

19. The method of claim 1, wherein the method further comprises reducing the amount of plant nutrients by 75, 50, or 25%, while still observing an increase in plant growth or yield.

20. The method of claim 1, wherein the method further comprises isolating an aloe vera gel that comprises between 2.0 to 7.5% weight/volume solids, gibberellic acid, and aloe vera lignins.

21. A composition for treating one or more pathogens that affect plants comprising:
an isolated whole leaf aloe vera extract, wherein the aloe vera leaf is processed to eliminate solids and to preserve the gel of the aloe vera gel and may further maintain or include additional aloin; and
at least one of diluting the whole leaf aloe vera extract and spraying the whole leaf aloe vera extract on the plants, wherein the aloe vera gel and aloin, or at least one of, stop the growth of, reduce the spread of, or kill the one or more pathogens.

22. The composition of claim 21, wherein the aloe vera gel is concentrated, lyophilized, liquid, or gel.

23. The composition of claim 21, further comprising at least one of a stabilizer, an anti-oxidant, a water-repellent, a UV absorbing agent, an anti-microbial agent, or combinations thereof.

24. The composition of claim 21, wherein the aloe vera gel is dried, ground, whole or concentrated.

25. The composition of claim 21, wherein the composition is at least one of repelling insects or pests without the addition of additional insecticides or pesticides.

26. The composition of claim 21, wherein the plant is orange, grapefruit, lemon, lime, mandarin, Satsuma, kumquat, jojoba, apple, cocoa, coffee or other flowering plant.

27. The composition of claim 21, wherein the composition increased leaf greenness (SPAD), and showed a significant gain in net photosynthesis (P_{N}).

28. The composition of claim 21, wherein the composition is used to treat Brown patch, turfgrass disease, damping off in seedlings, black scurf of potatoes, tomatoes, cabbage, bare patch of cereals, root rot of sugar beet, belly rot of cucumber, cacao fruit borer, brown plant hopper, vascular streak dieback, black pod rot, and sheath blight of rice.

29. The composition of claim 21, wherein the plant is a cereal, and the cereal plant is treated for Rhizoctonia sp., including Rhizoctonia solani, with the composition include wheat, barley, canola, green pea, and seeds thereof.

30. The composition of claim 21, wherein the seeds of the plant are treated with the composition during storage, prior to use, or when planted.

31. The composition of claim 21, wherein the composition is adapted to be coated on a seed of orange, grapefruit, lemon, lime, mandarin, Satsuma, kumquat, jojoba, apple, cocoa, coffee or other flowering plant.

32. The composition of claim 21, wherein the composition is defined further as comprising aloe vera gel that comprises between 2.0 to 7.5% weight/volume solids, gibberellic acid, and aloe vera lignins.
